(19) United States
(12) Patent Application Publication
(10) Pub. No.: US 2004/0142278 A1
(43) Pub. Date: Jul. 22, 2004

(54) Optical recording medium dye and optical recording medium using thereof

(76) Inventors: Chao-Nan Kuo, Hsinchu (TW); Mei-Jung Hu, Pingtung City (TW)

Correspondence Address: J.C. Patents, Inc., Suite 250, 4 Venture, Irvine, CA, 92618, US

(21) Appl. No.: 10/755,147

(22) Filed: Jan. 9, 2004

(30) Foreign Application Priority Data
Jan. 10, 2003 (TW) 92100471

(51) Int. Cl. G11B 7/24

(52) U.S. Cl. 430/270.21; 430/270.2; 430/945; 428/64.8

(57) ABSTRACT

An optical recording medium dye is disclosed. The optical recording medium dye comprises the following chemical structure:

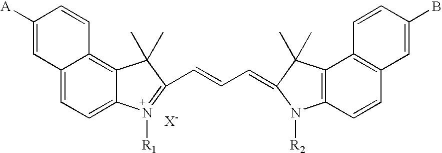

wherein A and B are of the same or different groups comprising hydrogen atom, halogen, nitrogen-containing group or alkoxyl group, R₁ and R₂ are selected from a group consisting of alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group, and X⁻ is an anion.

### CROSS-REFERENCE TO RELATED APPLICATION

This application claims the priority benefit of Taiwan application serial no. 92100471, filed on Jan. 10, 2003.

### BACKGROUND OF THE INVENTION

1. Field of the Invention

The present invention relates to a write-once digital optical recording medium. More particularly, the present invention relates to an optical recording medium dye, and an optical recording medium using thereof.

2. Description of the Related Art

A compact disc (“CD”) has become the main stream of optical information storage media due to the advantages of high storage density, small volume, long storage period, low cost, high compatibility and low failure rate. In a variety of types of CD, the most popular is a type of write-once CD, i.e., a compact disc-recordable (“CD-R”), in which the laser beam using for recording and reading operations has a wavelength in a range of about 770 nm to about 830 nm.

Therefore, with the popularity of application of multimedia to information, a lot of information contains a large number of texts, sounds and images; but, the 650 megabytes (“MB”) capacity of conventional CD-R is not suitable for the video and audio requirement of the next generation. Consequently, much of the high density write-once digital optical recording medium of the next generation has been set forth in recording medium that has a larger capacity than that of a CD-R, using a laser beam having a wavelength shorter than that of a CD-R, the wavelength of the recording medium being in a range of about 620 nm to about 690 nm for high density recording and reading operations. Therefore, a high density write-once digital optical recording medium having a higher capacity and shorter recording and reading laser wavelength will become main stream of the next generation.

The write-once digital optical recording medium uses organic optical dye for a material of recording layer, and uses a focused short wavelength laser beam for emitting on a recording layer to form pits for recording of data. A conventional material of organic optical dye includes cyanine dye, azo dye, benzofuryl ketone dye or indigo dye.

However, because cyanine dye has a lower decomposition temperature and a lower heat resistance, when a laser is emitted on a recording layer of CD-R composed of a cyanine dye for a recording operation, the accumulated heat may decompose a portion of the recording layer without pits and damage that portion of the recording layer. Moreover, even when a laser is emitted for a long time on the recording layer of a CD-R for a reading operation, the accumulated heat may also damage the portion of a recording layer without pits. Accordingly, the data on a CD-R composed with a conventional cyanine dye is easily damaged by a laser beam from the pick-up head.

### SUMMARY OF THE INVENTION

Accordingly, this invention provides an optical recording medium dye, and an optical recording medium using thereof. The optical recording medium dye of the present invention is a cyanine dye having a higher decomposition temperature than that of a conventional cyanine dye.

It is another object of the invention to provide an optical recording medium dye, and an optical recording medium using thereof. The optical recording medium dye of the present invention is a cyanine dye having a larger absorption wavelength than that of a conventional cyanine dye.

As embodied and broadly described herein, an optical recording medium dye of the present invention is a cyanine dye comprising the following chemical structure (I):

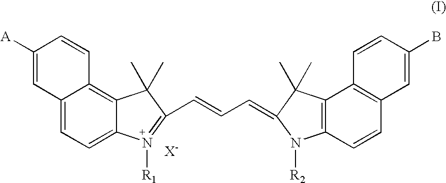

In the chemical structure (I), the substituent A and B are of the same or different groups including, but not limited to, hydrogen atom, halogen, nitrogen-containing group or alkoxyl group, in which the halogen includes fluorine, chlorine, bromine and iodine, the nitrogen-containing group being a substrate having primary amine group (—NH₂), secondary amine group (—NHR, wherein R is a hydrocarbon-containing group), tertiary amine group (—NR₂, wherein R is a hydrocarbon-containing group), nitro group, nitroso group. The substituent R₁, and R₂ are of the same or different substituent or non-substituent chain or branched groups including, but not limited to, alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group, and X⁻ is an anion.

As embodied and broadly described herein, an optical recording medium of the present invention is provided. The medium at least includes, but is not limited to, a substrate, a recording layer and a reflective layer. The recording layer is covered over the substrate and the recording layer is composed of at least one of the dyes comprising the following chemical structure (I):

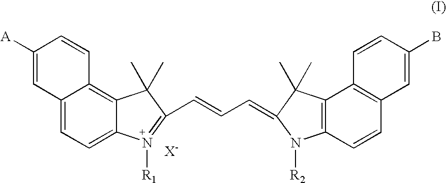

In the chemical structure (I), the substituent A and B are of the same or different groups including, but not limited to, hydrogen atom, halogen, nitrogen-containing group or alkoxyl group, in which the halogen includes fluorine, chlorine, bromine and iodine, the nitrogen-containing group is a substrate having primary amine group (—NH₂), secondary amine group (—NHR, wherein R is a hydrocarbon-containing group), nitro group, nitroso group. The substituent R₁ and R₂ are of the same or different substituent or non-substituent chain or branched groups including, but not limited to, alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group, and X⁻ is an anion.

Moreover, the reflective layer is covered over the recording layer.

Because the functional group of the substituent of the cyanine dye of the present invention includes, but is not limited to, halogen, primary amine group, secondary amine group, nitro group or nitroso group, the improved cyanine dye has a higher decomposition temperature and is not easily decomposed by accumulated heat. The accumulated heat also prevents the portion of recording layer without pits composed of the improved cyanine dye from decomposition and deformation, and the data recorded in the recording layer are safe and normal. Moreover, because the maximum absorption wavelength of the cyanine dye is larger than that of a conventional dye, the cyanine is applicable for a recording layer of a high-speed optical recording medium.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a thermal gravity analysis (“TGA”) graph for a cyanine dye of the preferred embodiment of the present invention; and

FIG. 2 illustrates an absorption spectrum for a cyanine dye of the preferred embodiment of the present invention.

### DESCRIPTION OF THE PREFERRED EMBODIMENTS

The present invention provides an optical recording medium dye in which the optical recording medium dye is a cyanine dye and comprises the following chemical structure (1):

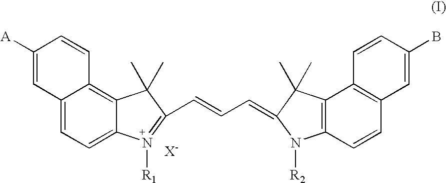

In the chemical structure (I), the substituent A and B are of the same or different groups including, but not limited to, hydrogen atom, halogen, nitrogen-containing group or alkoxyl group, in which the halogen includes fluorine, chlorine, bromine and iodine, the nitrogen-containing group being a substrate having primary amine group (—NH₂), secondary amine group (—NHR, wherein R is a hydrocarbon-containing group), tertiary amine group (—NR₂, wherein R is a hydrocarbon-containing group), nitro group, nitroso group. The substituent R₁ and R₂ are of the same or different substituent or non-substituent chain or branched groups including, but not limited to, alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group, and X− is an anion.

In the chemical structure (I), the alkyl group is a chain or branched alkyl group with carbon number one to eight (C₁₋₈) and includes, but is not limited to methyl, ethyl, proryl, iso-propyl, butyl, iso-butyl, tert-butyl, 1-methylbutyl, 2-methylbutyl, 3-methylbutyl, pentyl, iso-pentyl, neopentyl, tert-pentyl, 1-methylpentyl, 2-methylpentyl, 5-methylpentyl, hexyl, iso-hexyl, heptyl and octyl. The alkenyl group includes, but is not limited to vinyl, 1-propenyl, 2-propenyl, iso-propenyl, 2-butenyl, 1,3-butadienyl and 2-pentenyl. The aralkyl is composed of, for example but is not limited to, one to three or five methylene groups, and both ends of the aralkyl compound are connected to monocyclic group, saturated polycyclic group, unsaturated hydrocarbon group, heterocyclic group, phenyl, biphenyl, o-tolyl, m-tolyl, p-tolyl, o-cumenyl, m-cumenyl, p-cumenyl, xylyl, mesityl, styryl, cinnamoyl and naphthyl. The alkoxycarbonyl group includes, but is not limited to methoxycarbonyl, ethoxycarbonyl, n-propoxycarbonyl, iso-propoxycarbonyl, n-butoxycarbonyl, iso-butoxycarbonyl and tert-butoxycarbonyl. The alkoxycarboxyl group includes, but is not limited to methoxycarboxyl, ethoxycarboxyl, n-propoxycarboxyl, iso-propoxycarboxyl, n-butoxycarboxyl, iso-butoxycarboxyl, and tert-butoxycarboxyl. The alkoxyl group includes, but is not limited to methoxyl, ethoxyl, n-propoxyl, iso-propoxyl, n-butoxyl, i-butoxyl, t-butoxyl and pentoxyl. The alkyl hydroxyl group includes, but is not limited to methoxyhydroxyl, ethoxyhydroxyl, n-propoxyhydroxyl, iso-propoxyhydroxyl, n-butoxyhydroxyl, iso-butoxyhydroxyl and tert-butoxyhydroxyl. The alkylamino group includes, but is not limited to methylamino, ethylamino, n-propylamino, n-butylamino, dimethylamino and diethylamino. The alkylcarbamoyl group includes, but is not limited to methylcarbamoyl, ethylcarbamoyl, n-propylcarbamoyl, iso-propylcarbamoyl, n-butylcarbamoyl, iso-butylcarbamoyl and tert-butylcarbamoyl. The alkylsulfamoyl group includes, but is not limited to methylsulfamoyl, ethylsulfamoyl, n-propylsulfamoyl, iso-propylsulfamoyl, n-butylsulfamoyl, iso-butylsulfamoyl and tert-butylsulfamoyl. The alkylalkoxyl group includes, but is not limited to methylmethoxyl, ethylmethoxyl, n-propylmethoxyl, iso-propylmethoxyl, n-butylmethoxyl, iso-butylmethoxyl and tert-butylmethoxyl. The alkylsulfonyl group includes, but is not limited to methylsulfonyl, ethylsulfonyl, n-propylsulfonyl, iso-propylsulfonyl, n-butylsulfonyl, iso-butylsulfonyl and tert-butylsulfonyl. The alkylcarboxyl group includes, but is not limited to methylcarboxyl, ethylcarboxyl, n-propylcarboxyl, iso-propylcarboxyl, n-butylcarboxyl, iso-butylcarboxyl and tert-Butylcarboxyl.

In the chemical structure (I), the X⁻ is an anion of inorganic acid, in which the inorganic acid includes, but is not limited to fluoric acid, chloric acid, bromic acid, iodic acid, perchloric acid, periodic acid, phosphoric acid, phosphoric acid hexafluoride, antimony hexafluoride, tin acid hexafluoride and fluoroboric acid. Or the X⁻ is an anion of organic acid, in which the organic acid includes, but is not limited to thiocyanic acid, benzenesulfonic acid, p-toluenesulfonic acid, alkylsulfonic acid, benzenecarboxylic acid, alkylcarboxylic acid, trihaloalkylcarboxylic acid, trihaloalkylsulfonic acid, nicotinic acid and thiocyanate (“SCN⁻”).

Now, the experimental examples 1 to 3 will be described in the following delineating the present invention, however, the claims of the present invention are not limited to the experimental examples 1 to 3.

### EXAMPLE 1

The first experimental example is an example of forming a cyanine dye. The starting materials 1-methyl-2.3.3-trimethyl-6-bromo-benzo[e]indolium iodide 5 gram (“g”) and triethyl orthoformate 0.85 g are dissolved in 10 ml pyridine solution, after heated to the reflux temperature 120 ° C. for 3 hours, the solution is cooled down to room temperature. The solution obtained above is slowly added into a mixture of 6N hydrochloric (“HCL”) acid 50 ml and distilled water 250 ml to form a mixture solution; after the mixture solution is stirred for 8 hours, the mixture solution is filtered, the filtered solid being a dye composed of bis(1-methyl-3.3-dimethyl-6-bromo-benzo[e]indo)-2:2′-propylmethine iodide having a weight of about 2.6 g. The filtered solid and potassium hexafluorophosphate (“KPF₆”) 2.5 g are dissolved in methanol 30 ml, stirred for 24 hours and then filtered, the filtered solid being a cyanine dye composed of bis (1-methyl-3.3-dimethyl-6-bromo-benzo[e]indo)-2:2′-propylmethine hexafluorophosphate having a weight of about 1.5 g. The obtained cyanine dye has the following chemical structure (II):

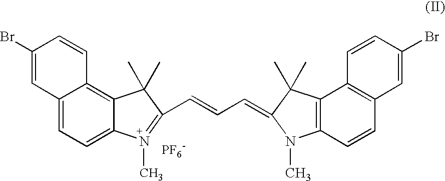

### EXAMPLE 2

The second experimental example is an example of forming a cyanine dye. The starting materials 1-butyl-2.3.3-trimethyl-6-bromo-benzo[e]indolium iodide 4.6 g and 1-butyl-2-(anilinovinyl)-3.3-dimethyl-benzo[e]indolium iodide 5 g are dissolved in a mixture of pyridine 10 ml, glacial acetic acid 2.4 ml and triethyl amine 2.5 ml to form a solution. After the solution is heated to the reflux temperature for 3 hours, the solution is cooled down to room temperature. The solution obtained above is slowly added into a mixture of 6N hydrochloric (“HCL”) acid 50 ml and distilled water 250 ml to form a mixture solution; after the mixture solution is stirred for 8 hours, the mixture solution is filtered and the filtered solid is a dye composed of 1-butyl-3.3-dimethyl-1′-butyl-3′.3′-dimethyl-6′-bromo-bis-benzo[e]indo-2:2′-propylmethine iodide having weight of about 3.1 g. The filtered solid and sodium perchlorate monohydrate (“NaClO₄.H₂O”) 6 g is dissolved in methanol 35 ml, stirred for 24 hours and then filtered; finally, the filtered solid is a cyanine dye composed of 1-butyl-3.3-dimethyl-1′-butyl-3′.3′-dimethyl-6′-bromo-bis-benzo[e]indo-2:2′-propylmethine perchlorate having a weight of about 1.5 g. The obtained cyanine dye has the following chemical structure (III):

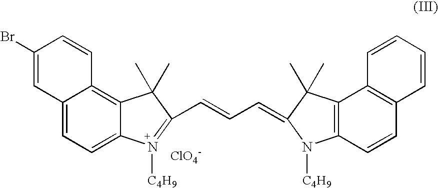

### EXAMPLE 3

The third experimental example is an example of manufacturing an optical recording medium using the cyanine dye obtained in the first and second example. The starting materials, cyanine dye obtained in the first and second example, are dissolved in organic solvent to obtain a cyanine dye solution. Then a first substrate is provided and the cyanine dye solution is spin coated on the first substrate to form a coated layer. Thereafter, the coated substrate obtained above is proceeded by a baking process in order to transform the coated layer on the substrate into a cyanine dye layer, and the cyanine dye layer serves as a recording layer of an optical recording medium, then a reflective layer is formed on the cyanine dye layer. After that, a second substrate is disposed on the reflective layer, and the blank second substrate is attached to the first substrate having a reflective layer and a cyanine dye layer. Thus, a high density recordable disk is manufactured. The method of attaching the second substrate to the first substrate includes, but not limited to, spin coating, screen printing and hot melt glue coating method.

The optical recording medium obtained above is rotated under 7 m/s and emitted by a semiconductor laser beam having a wavelength of about 658 nm and a power of about 13 MW, in order to record an eight to fourteen modulation signal. Thereafter, a reading test of the recorded optical recording medium above proceeds in a digital versatile disc (“DVD”) having a pick-up head semiconductor laser of wavelength 658 nm. The test results have an excellent reading signal.

Moreover, referring to TABLE 1, the cyanine dye [1] to [9] are related to the cyanine dye having the substituent A, B, R₁, R₂ and X replaced by the substituent described in the preferred embodiments of the present invention. Also, the thermal decomposition temperature and the maximum absorption wavelength are related to the measured results of that of the cyanine dye. Moreover, the cyanine dye [10] in TABLE 1 is referred to a cyanine dye disclosed in the Japanese publication H11-34499 in the early days, in which the maximum absorption wavelength is described and the thermal decomposition temperature is measured by a compound of cyanine dye [10].

TABLE 1

| | Maximum | |
|---|---|---|
| | absorption | Decomposition |
| | wavelength | temperature |
| Cyanine dye | in alcohol (nm) | (° C.) |
| [1] A═B═Br, R₁═R₂═methyl, | 586.8 | 305 |
| X═ClO₄ | | |
| [2] A═B═Br, R₁═R₂═methyl, | 586.8 | 330 |
| X═PF₆ | | |
| [3] A═B═Br, R₁═methyl, | 588.8 | 269 |
| R₂═butyl, X═ClO₄ | | |
| [4] A═B═Br, R₁═R₂═butyl, | 590.8 | 318 |
| X═ClO₄ | | |
| [5] A═B═Br, R₁═R₂═butyl, | 590.8 | 301 |
| X═PF₆ | | |
| [6] A═H, B═Br, R₁═R₂═butyl, | 589.2 | 287 |
| X═ClO₄ | | |
| [7] A═Br, B═H , R₁═methyl, | 587.2 | 257 |
| R₂═butyl, X═ClO₄ | | |
| [8] A═H, B═Br, R₁═methyl, | 587.4 | 261 |
| R₂═butyl, X═ClO₄ | | |
| [9] A═H, B═Br, R₁═R₂═methyl, | 585.4 | 260 |
| X═ClO₄ | | |
| [10] A═B═H, R₁═R₂═butyl, | 588 | 245 |
| X═ClO₄ | | |

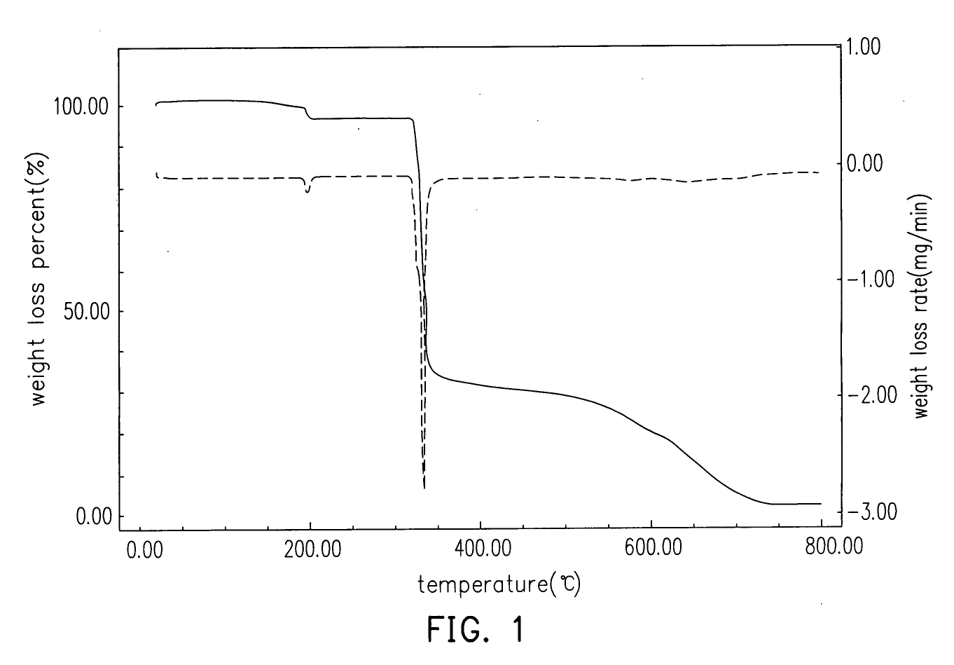

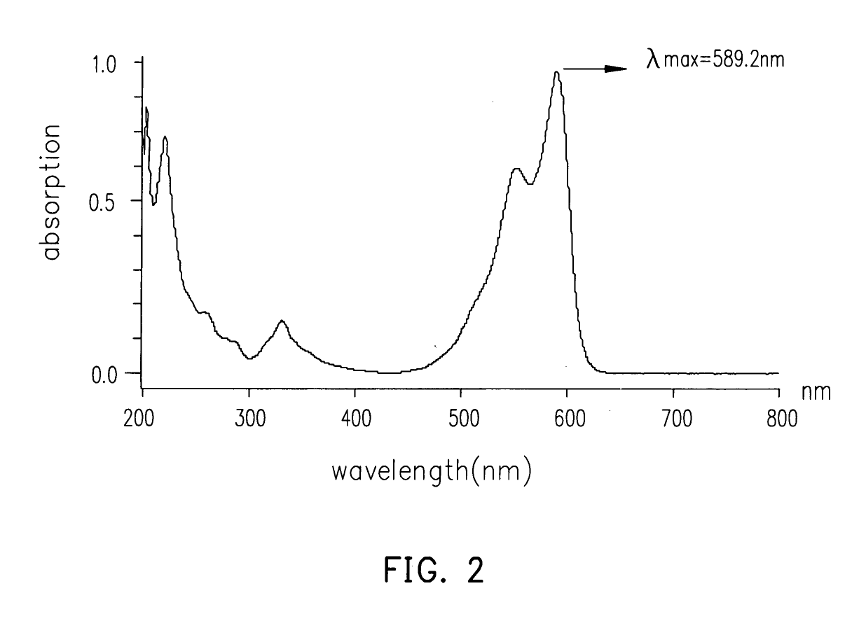

Referring to FIG. 1 and TABLE 1 simultaneously, FIG. 1 is a thermal gravity analysis (“TGA”) graph for the cyanine dye [2] in TABLE 1 obtained in the first example. As shown in FIG. 1, a rapid weight loss occurs at 330° C., signifying that the decomposition temperature of the cyanine dye [2] is about 330° C. Thereafter, referring to FIG. 2 and TABLE 1 simultaneiously, FIG. 2 is an absorption spectrum for the cyanine dye [6] in the TABLE 1 obtained in the second example. As shown in FIG. 2, a maximum absorption wavelength of the cyanine dye [6] is about 589.2 nm. Moreover, referring to TABLE 1, because the substituent A and B of the cyanine dye [10] is not replaced by any related functional groups disclosed in the present invention, the decomposition temperature of the cyanine dye [10] is lower than any one of the cyanine dye disclosed in the present invention.

Accordingly, since the functional group of the substituent A and B of the cyanine dye of the present invention is of the same or different groups including, but not limited to, halogen, primary amine group, secondary amine group, tertiary amine group, nitro group or nitroso group, the improved cyanine dye has a higher decomposition temperature and is not easily decomposed by accumulated heat. The accumulated heat prevents the portion of CD-R recording layer without pits composed of the cyanine dye from decomposition and deformation. The data recorded in the recording layer is safe and normal. Moreover, because the absorption wavelength of the cyanine dye is larger than that of a conventional dye, the cyanine is applicable for a recording layer of a high-speed optical recording medium.

Moreover, the optical recording medium dye of the present invention can be broadly applied to a variety of optical recording media including, but not limited to, compact disc (“CD”), DVD, mini disc (“MD”), compact disc for video (“CDV”), digital audio tape (“DAT”), compact disc-read only memory (“CD-ROM”) and digital versatile disc-read only memory (“DVD-ROM”).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical recording medium dye, comprising the following chemical structure (I): 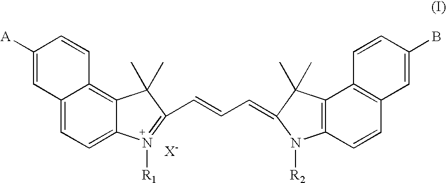
wherein A and B are hydrogen atom, halogen, or nitrogen-containing group, wherein A and B are not hydrogen atom simultaneously;
wherein R₁ and R₂ are selected from a group consisting of alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group; and
wherein X⁻ is an anion.

2. The optical recording medium dye of claim 1, wherein the nitrogen-containing group is primary amine group, secondary amine group, tertiary amine group, nitro group or nitroso group.

3. The optical recording medium dye of claim 1, wherein A and the B are the same.

4. The optical recording medium dye of claim 1, wherein A and the B are different.

5. The optical recording medium dye of claim 1, wherein R₁ and R₂ are the same.

6. The optical recording medium dye of claim 1, wherein R₁ and R₂ are different.

7. The optical recording medium dye of claim 1, wherein X⁻ is an anion selected from a group consisting of fluoric acid, chloric acid, bromic acid, iodic acid, perchloric acid, periodic acid, phosphoric acid, phosphoric acid hexafluoride, antimony hexafluoride, tin acid hexafluoride and fluoroboric acid.

8. The optical recording medium dye of claim 1, wherein X⁻ is an anion selected from a group consisting of thiocyanic acid, benzenesulfonic acid, p-toluenesulfonic acid, alkylsulfonic acid, benzenecarboxylic acid, alkylcarboxylic acid, trihaloalkylcarboxylic acid, trihaloalkylsulfonic acid, nicotinic acid or thiocyanate.

9. The optical recording medium dye of claim 1, wherein A and B are alkoxyl group.

10. An optical recording medium, comprising:
a substrate;
a recording layer composed of an optical recording medium dye comprising the following chemical structure (I): 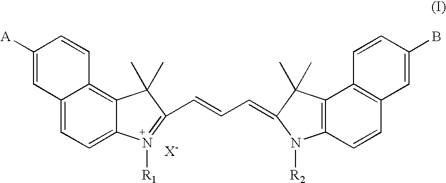
wherein A and B are hydrogen atom, halogen, or nitrogen-containing group, wherein A and B are not hydrogen atom simultaneously;
wherein R₁ and R₂ are selected from a group consisting of alkyl group, alkenyl group, aralkyl group, alkoxycarbonyl group, alkoxycarboxyl group, alkoxyl group, alkyl hydroxyl group, alkylamino group, alkylcarbamoyl group, alkylsulfamoyl group, alkylalkoxyl group, alkyl halide group, alkylsulfonyl group or alkylcarboxyl group; and
wherein X⁻ is an anion; and
a reflective layer formed over the recording layer.

11. The optical recording medium of claim 10, wherein the nitrogen-containing group is primary amine group, secondary amine group, tertiary amine group, nitro group or nitroso group.

12. The optical recording medium of claim 10, wherein A and the B are the same.

13. The optical recording medium of claim 10, wherein A and the B are different.

14. The optical recording medium of claim 10, wherein R₁ and the R₂ are the same.

15. The optical recording medium of claim 10, wherein R₁ and the R₂ are different.

16. The optical recording medium of claim 10, wherein X⁻ is an anion selected from a group consisting of fluoric acid, chloric acid, bromic acid, iodic acid, perchloric acid, periodic acid, phosphoric acid, phosphoric acid hexafluoride, antimony hexafluoride, tin acid hexafluoride and fluoroboric acid.

17. The optical recording medium of claim 10, wherein X⁻ is an anion selected from a group consisting of thiocyanic acid, benzenesulfonic acid, p-toluenesulfonic acid, alkylsulfonic acid, benzenecarboxylic acid, alkylcarboxylic acid, trihaloalkylcarboxylic acid, trihaloalkylsulfonic acid, nicotinic acid and thiocyanate.

18. The optical recording medium of claim 10, wherein A and B are alkoxyl group.
